(19) United States
(12) Patent Application Publication
(10) Pub. No.: US 2008/0230964 A1
(43) Pub. Date: Sep. 25, 2008

(54) Tungsten Shot

(75) Inventors: Hans Wohlfromm, Mannheim (DE); Johan Herman Hendrik ter Maat, Mannheim (DE); Martin Blomacher, Meckenheim (DE)

Correspondence Address: CONNOLLY BOVE LODGE & HUTZ, LLP, P O BOX 2207, WILMINGTON, DE, 19899, US

(73) Assignee: BASF SE, Ludwigshafen (unknown)

(21) Appl. No.: 12/067,552

(22) PCT Filed: Aug. 29, 2006
(86) PCT No.: PCT/EP2006/065754

§ 371 Date: Mar. 20, 2008

(30) Foreign Application Priority Data
Sep. 21, 2005 (DE) 10 2005 045 046.6

(51) Int. Cl. B22F 1/00; C22C 1/04; C04B 35/64; B22F 3/10

(52) U.S. Cl. 264/654; 419/3

(57) ABSTRACT

The present invention relates to a process for the production of sintered three-dimensional strips of shaped bodies and for the production of the shaped bodies from a pulverulent, inorganic material, to sintered three-dimensional shaped bodies and to the use of the sintered, three-dimensional shaped bodies as shot pellets, munitions, angling weights, for balancing tires, as oscillating weight in clocks, for radiation screening, as a balancing weight in drive motors and engines, for the production of sports equipment or as a catalyst support.

The present invention relates to a process for the production of strips of sintered three-dimensional shaped bodies or for the production of sintered three-dimensional shaped bodies from a pulverulent, inorganic material by mixing this material with a binder and if appropriate a dispersant, forming this mixture into a melt strip, forming it into a continuous strip of three-dimensional shaped bodies, if appropriate singulating these shaped bodies, debindering and sintering, and to the use of the sintered three-dimensional shaped bodies.

Processes for the production of shaped bodies from inorganic materials are already known.

WO 01/81467 A1 discloses a binder for inorganic material powders for the production of metallic and ceramic shaped bodies. A mixture of the inorganic material powder with a binder selected from the group consisting of polyoxymethylene homopolymers and copolymers, polytetrahydrofuran and a further polymer, is shaped by the injection-molding process known from the prior art.

U.S. Pat. No. 6,270,549 B1 discloses a formable, non-toxic tungsten-nickel-manganese-iron alloy with a high density. The document also discloses a process for producing shot pellets by casting or forging.

JP 06271970 A discloses a sintered tungsten alloy, comprising 85 to 98% tungsten, together with iron and nickel, with the ratio of nickel to iron being from 5/5 to 8/2. This mixture is shaped using methods known from the prior art and sintered using a specific temperature program.

U.S. Pat. No. 4,784,690 discloses a tungsten alloy with a relatively low density and a process for producing shaped parts therefrom. This process includes the pressing of an alloy powder which comprises no more than 90% by weight tungsten, followed by sintering of this shaped body in a reducing atmosphere.

US 2003/0172775 A1 discloses an alloy comprising 30 to 75% by weight tungsten, 10 to 70% by weight nickel, 0 to 35% by weight iron, if appropriate with a ratio of nickel to iron of ≧1.0 or if appropriate of <1.0, as well as a process for producing bullets from said alloy by casting, forging, swaging and/or grinding.

It is an object of the present invention to provide a process for the simple and therefore inexpensive production of sintered strips of three-dimensional shaped bodies from a pulverulent inorganic material and for the production of corresponding three-dimensional shaped bodies.

This object is achieved by a process for the production of continuous strips of sintered three-dimensional shaped bodies or for the production of three-dimensional shaped bodies from a pulverulent, inorganic material, wherein
(a) a mixture of the pulverulent, inorganic material is mixed with a binder and if appropriate a dispersant,
(b) the mixture is formed into a melt strip by means of a suitable apparatus,
(c) this melt strip is formed into a continuous strip of three-dimensional shaped bodies by means of a suitable apparatus,
(d) if appropriate after cooling the continuous strip of three-dimensional shaped bodies is singulated,
(e) the strip of three-dimensional shaped bodies or the three-dimensional shaped bodies are debindered,
(f) the debindered three-dimensional strip of the shaped bodies or the debindered three-dimensional shaped bodies are sintered, and
(g) if appropriate after cooling the continuous strip of the debindered, sintered three-dimensional shaped bodies is singulated, if the singulation did not take place in step (d).

The process according to the invention includes, as a first step, the pulverulent, inorganic material being mixed with a binder and if appropriate a dispersant.

The inorganic material can be selected from all known, suitable inorganic sinterable powders. It is preferably selected from the group consisting of metal powders, metal alloy powders, semimetal powders, metal carbonyl powders, ceramic powders and mixtures thereof.

Examples which may be mentioned of metals that can be in powder form include tungsten, iron, cobalt, nickel, silicon, aluminum, titanium and copper. Examples of alloys include light metal alloys based on aluminum and titanium, as well as alloys of copper and all steels known to a person skilled in the art.

Semimetals, such as tungsten carbide, boron carbide or titanium nitride, alone or in combination with metals, such as for example cobalt, nickel and iron, are also suitable.

Suitable inorganic powders also include oxidic ceramic powders, such as Al₂O₃, ZrO₂, Y₂O₃, but also nonoxidic ceramic powders, such as silicon carbide, Si₃N₄. Examples of suitable powders are described in EP-A-0 456 940, EP-A-0 710 516, DE-A-3 936 869, DE-A-4 000 278 and EP-A-0 114 746, as well as the literature cited therein.

In a further preferred embodiment, the inorganic material comprises
25-64% by weight, particularly preferably 40-64% by weight, very particularly preferably 50-60% by weight, tungsten,
10-42% by weight, particularly preferably 10-35% by weight, very particularly preferably 10-30% by weight, iron,
14-55% by weight, particularly preferably 14-40% by weight, very particularly preferably 14-35% by weight, nickel, and
≦5% by weight of other suitable inorganic materials,
   with the sum amounting to 100% by weight.

The grain sizes of the powders are preferably 0.1 to 50 μm, particularly preferably 0.2 to 30 μm. The metal powders, metal alloy powders, semimetal powders, metal carbonyl powders and/or ceramic powders can also be used in a mixture.

If one of the abovementioned mixtures of the metals tungsten, iron and nickel is used as pulverulent inorganic material in the process according to the invention, in this mixture the weight ratio of nickel to iron is preferably from 38:62 to 78:22, particularly preferably from 42:68 to 70:30.

Any common, preferably organic binder which can be removed without residues can be used as binder in the process according to the invention. These organic binders can be selected from the group consisting of polyoxymethylene homopolymers and copolymers, polyalkylene oxides, preferably polytetrahydrofuran, polyolefins, polymers of acrylic acid and/or acrylic acid esters, preferably polymethyl methacrylate, if appropriate with the addition of dispersing auxiliaries and flow improvers. It is preferable to use mixtures of the abovementioned binders, preferably a mixture of polyoxymethylene and a polyolefin, if appropriate with the addition of dispersing auxiliaries and flow improvers. Suitable binders and binder mixtures are described in WO 01/81467A1, EP 0 465 940 B1 and EP 0 444 475 B1.

The binder is used in a proportion of from 60 to 98% by weight, preferably 70 to 95% by weight, particularly preferably 75 to 95% by weight, based on the mixture of pulverulent, inorganic material powder, binder and if appropriate dispersing auxiliaries.

In the process according to the invention, in step (a) the pulverulent inorganic material or a mixture of inorganic pulverulent materials is mixed with a binder and if appropriate a dispersant using a method known to a person skilled in the art.

In addition to the material powder and the binder, the mixture may also if appropriate comprise a dispersing auxiliary and a flow improver selected from dispersing auxiliaries and flow improvers known to a person skilled in the art.

In addition, the mixtures may also comprise standard additives and processing auxiliaries which have a favorable influence on the rheological properties of the mixtures during forming.

According to the invention, the mixtures can be produced by melting the binder and mixing in the inorganic powder and if appropriate the dispersing auxiliary. The powder can be melted, for example in a twin-screw extruder, at temperatures of preferably 150 to 220° C., particularly preferably 170 to 200° C. The inorganic binder is then added to the melt stream of the binder in the required quantity at temperatures in the same range. The inorganic powder advantageously comprises the dispersing auxiliary (auxiliaries) on the surface.

According to the invention, the mixture can also be obtained by mixing the binder and the inorganic powder at room temperature using processes known to a person skilled in the art.

Producing the mixture by melting the binder and adding the inorganic powder has the advantage over mixing the components at room temperature followed by extrusion with an increase in temperature that decomposition of the polyoxymethylene used as binder as a result of the high shear forces occurring with the latter variant is substantially avoided.

Step (b) of the process according to the invention involves the mixture of inorganic material powder, binder and if appropriate a dispersing auxiliary which has previously been produced being formed into a melt strip on a suitable apparatus, preferably a kneader or twin-screw extruder. According to the invention, it is possible to use all apparatuses which are known to a person skilled in the art and are suitable for the processing of the mixtures that can be used according to the invention.

For this purpose, the mixture from step (a) of the process according to the invention, if the components have been mixed at room temperature or a temperature below the melting point, is melted. This takes place at a temperature from 150 to 210° C., preferably from 160 to 210° C., particularly preferably from 170 to 190° C. The molten mixture can then be discharged in the form of a strand using all methods known to a person skilled in the art. It is preferable for the mixture to be melted on a twin-screw extruder and discharged via a die to form an extruded strand.

If the mixture in step (a) of the process according to the invention has been produced by melting the binder and adding the inorganic powder, the molten mixture can be directly formed into a melt strip, without the mixture having to be temporarily cooled and then melted again.

While the molten mixture obtained in step (b) is being shaped using a suitable apparatus, for example on a calender, the mixture is cooled. This can take place for example by cooling the apparatus with water.

In step (c), the molten mixture in strand form obtained in step (b) is formed into a continuous strip of three-dimensional shaped bodies. This forming operation can be carried out using any apparatus which is known to a person skilled in the art and is suitable for the process step according to the invention. It is preferable for step (c) of the process according to the invention to be carried out by means of a calender. The continuous strips of three-dimensional shaped bodies produced according to the invention may according to the invention have any length; in a preferred embodiment, the strips are endless. The width of the strips of three-dimensional shaped bodies is up to 100 mm, preferably up to 60 mm, particularly preferably up to 30 mm. The continuous strips produced in accordance with the invention are from 0.1 to 20 mm high, preferably 0.5 to 10 mm high, particularly preferably 1.5 to 5 mm high. The individual three-dimensional shaped bodies are joined to one another by a melt film and therefore form the melt strip which can be used in accordance with the invention.

In step (d), the continuous strip of the three-dimensional shaped bodies obtained in step (c) is if appropriate after cooling singulated to give three-dimensional shaped bodies. The singulating can be carried out using all apparatuses which are known to a person skilled in the art and are suitable for this process step. By way of example, mention may be made of a drum mill or a barrel mixer.

The three-dimensional shaped bodies obtained as a result of the singulation in a preferred embodiment have a dimension along their longest extent of from 0.1 to 20 mm, preferably from 0.5 to 10 mm, particularly preferably from 1.5 to 5 mm.

In a preferred embodiment, the three-dimensional shaped bodies are spherical, ellipsoidal or drop-shaped, particularly preferably spherical.

In process step (e), the strips of three-dimensional shaped bodies obtained in step (c) or the singulated three-dimensional shaped bodies obtained in step (d) are debindered. In the context of the invention, the term debinder means that the binder admixed in process step (a), together with any dispersing auxiliary present, are removed.

To remove the binder, the strips of the three-dimensional shaped bodies or the three-dimensional shaped bodies obtained after the singulation are treated, for example, with a gaseous, acid-containing atmosphere. Suitable processes are described in DE-A-3929869 and DE-A-4000278. According to the invention, this treatment is preferably carried out at temperatures in the range from 20 to 180° C. for a period of preferably 0.1 to 24 hours, preferably 0.5 to 12 hours. The debindering can also be carried out using suitable debindering agents in the liquid phase.

Suitable acids for the treatment in step (e) of the process according to the invention include, for example, inorganic acids which are either already in gas form at room temperature or at least can be evaporated at the treatment temperature. Examples include hydrohalic acids and nitric acid. Suitable organic acids are organic acids which at standard pressure have a boiling point of less than 130° C., such as formic acid, acetic acid or trifluoroacetic acid and mixtures thereof.

Furthermore, it is also possible for boron trifluoride (BF₃) and its adducts with organic ethers, preferably tetrahydrofuran, to be used as acid. The treatment time required depends on the treatment temperature and the concentration of the acid in the treatment atmosphere and also on the size of the shaped body.

If a carrier gas is used, this is generally laden with the acid by the carrier gas being brought into contact with the acid in the gaseous state. The carrier gas which has been laden with acid in this way is then brought to the treatment temperature, which is expediently higher than the temperature at which it is laden with the acid, in order to avoid condensation of the acid. It is preferable for the acid to be admixed to the carrier gas via a metering device and for the mixture to be heated until the acid can no longer condense. Suitable carrier gases include inert gases, for example nitrogen or argon.

The acid treatment is preferably carried out until at least 80% by weight, preferably at least 90% by weight, of the binder has been removed. This can be checked, for example, on the basis of the reduction in weight. Then, the product obtained in this way is slowly heated to a temperature of 250-700° C., preferably 400-700° C.

Thereafter, the temperature is kept constant. The heating time comprising slow heat-up and heating at constant temperature in total amounts to preferably 0.1 to 12 hours, particularly preferably 0.3 to 6 hours. This heating is carried out in order to completely remove the remainder of the binder.

In process step (f), the debindered strips of three-dimensional shaped bodies or the debindered singulated three-dimensional shaped bodies are sintered in the usual way. As a result, the debindered strips of three-dimensional shaped bodies or the debindered singulated three-dimensional shaped bodies are converted into the desired strips of shaped bodies or the singulated shaped bodies, in particular metallic or ceramic.

The sintering is carried out at a temperature of from 500 to 2500° C., preferably 700 to 2000° C., particularly preferably 1200 to 1800° C. The sintering takes place in a hydrogen-containing atmosphere; the atmosphere preferably comprises hydrogen or is a hydrogen-comprising atmosphere which additionally includes nitrogen and/or argon. The sintering can also be carried out in vacuo. The duration of the sintering operation including cooling is less than 30 hours, preferably 8 to 24 hours, particularly preferably 8 to 12 hours.

If appropriate, if this has not already taken place in step (d) of the process according to the invention, the continuous strip of the debindered sintered three-dimensional shaped bodies obtained in step (f) is singulated to form debindered sintered three-dimensional shaped bodies. The singulation can be carried out as described in step (d).

The strips of three-dimensional shaped bodies or the three-dimensional shaped bodies produced by the process according to the invention have a density of preferably from 3 to 20 g/cm³, particularly preferably from 8 to 14 g/cm³.

The present invention also relates to strips of debindered sintered three-dimensional shaped bodies or to debindered sintered three-dimensional shaped bodies, produced by the process according to the invention.

The present invention also relates to the use of the three-dimensional shaped bodies produced by the process according to the invention as shot pellets, munitions, angling weights, for balancing tires, as oscillating weight in clocks, for radiation screening, as a balancing weight in drive motors and engines, for the production of sports equipment or as a catalyst support.

The following examples are intended to provide a more detailed explanation of the invention, without restricting it in any way.

### EXAMPLES

### Example 1

In the first example, an alloy composition comprising 57% by weight tungsten, 26% by weight iron and 17% by weight nickel is selected. In a heated kneader, a powder mixture comprising 400 kg of tungsten powder (mean particle diameter 6 μm), 218 kg of iron powder (mean particle diameter 5 μm) and 83 kg of nickel powder (mean particle diameter 13 μm) is mixed with 61 kg of polyoxymethylene and 7 kg of polypropylene to form a homogeneous mass, is kneaded and broken up as it is discharged. The granules obtained in this way are melted again on a twin-screw extruder and discharged via a die to form an extruded strand, which in turn is formed, by means of a calender, into a strip comprising spheres with a diameter of 3 mm which are connected to one another by a melt film. The cooled strips are broken into individual spheres by means of a drum mill.

The spheres are introduced as a bulk bed into a chamber furnace and catalytically debindered at 110° C. in a nitrogen stream of 500 l/h, to which 25 ml/h of concentrated HNO₃ have been added. Then, the bulk bed of spheres is added to an electrically heated sintering furnace, where it is sintered at 1420° C. in a stream of hydrogen.

The density of the sintered spheres is 12 g/cm³.

### Example 2

The alloy composition is selected to be 57% by weight tungsten, 12% by weight iron and 31% by weight nickel. The processing is carried out analogously to Example 1. In this case too, a density of 12 g/cm³ is achieved.

### Example 3

Aluminum oxide is selected as inorganic material. The process is carried out analogously to Example 1.

1-9. (canceled)

10. A process for the production of continuous strips of sintered three-dimensional shaped bodies or for the production of sintered three-dimensional shaped bodies from a pulverulent, inorganic material, wherein
(a) a mixture of the pulverulent, inorganic material is mixed with a binder and if appropriate a dispersant,
(b) the mixture is formed into a melt strip by means of a suitable apparatus,
(c) this melt strip is formed into a continuous strip of three-dimensional shaped bodies by means of a suitable apparatus,
(d) if appropriate after cooling the continuous strip of three-dimensional shaped bodies is singulated,
(e) the strip of three-dimensional shaped bodies or the three-dimensional shaped bodies are debindered,
(f) the debindered three-dimensional strip of the shaped bodies or the debindered three-dimensional shaped bodies are sintered, and
(g) if appropriate after cooling the continuous strip of the debindered, sintered three-dimensional shaped bodies is singulated, if the singulation did not take place in step (d).

11. The process according to claim 10, wherein the inorganic material is selected from the group consisting of metal powders, metal alloy powders, semimetal powders, metal carbonyl powders, ceramic powders and mixtures thereof.

12. The process according to claim 10, wherein the inorganic material comprises
25-64% by weight tungsten,
10-42% by weight iron,
14-55% by weight nickel, and
≦5% by weight of other suitable inorganic materials, with the sum amounting to 100% by weight.

13. The process according to claim 12, wherein in the inorganic material the ratio of nickel to iron is from 38:62 to 78:22.

14. The process according to claim 10, wherein the three-dimensional shaped bodies are spherical, ellipsoidal or drop-shaped.

15. The process according to claim 10, wherein the three-dimensional shaped bodies have a dimension along their longest extent of from 0.1 to 20 mm.

16. The process according to claim 10, wherein the binder is a compound selected from the group consisting of polyoxymethylene homopolymers and copolymers, polyalkylene oxides, polyolefins and polymers of acrylic acid and/or acrylic acid esters.

17. The process according to claim 11, wherein the inorganic material comprises
25-64% by weight tungsten,
10-42% by weight iron,
14-55% by weight nickel, and
≦5% by weight of other suitable inorganic materials, with the sum amounting to 100% by weight.

18. The process according to claim 11, wherein the three-dimensional shaped bodies are spherical, ellipsoidal or drop-shaped.

19. The process according to claim 11, wherein the three-dimensional shaped bodies have a dimension along their longest extent of from 0.1 to 20 mm.

20. The process according to claim 11, wherein the binder is a compound selected from the group consisting of polyoxymethylene homopolymers and copolymers, polyalkylene oxides, polyolefins and polymers of acrylic acid and/or acrylic acid esters.

21. The process according to claim 12, wherein the three-dimensional shaped bodies are spherical, ellipsoidal or drop-shaped.

22. The process according to claim 12, wherein the three-dimensional shaped bodies have a dimension along their longest extent of from 0.1 to 20 mm.

23. The process according to claim 12, wherein the binder is a compound selected from the group consisting of polyoxymethylene homopolymers and copolymers, polyalkylene oxides, polyolefins and polymers of acrylic acid and/or acrylic acid esters.

24. The process according to claim 13, wherein the three-dimensional shaped bodies are spherical, ellipsoidal or drop-shaped.

25. The process according to claim 13, wherein the three-dimensional shaped bodies have a dimension along their longest extent of from 0.1 to 20 mm.

26. The process according to claim 13, wherein the binder is a compound selected from the group consisting of polyoxymethylene homopolymers and copolymers, polyalkylene oxides, polyolefins and polymers of acrylic acid and/or acrylic acid esters.

27. The process according to claim 14, wherein the three-dimensional shaped bodies are spherical, ellipsoidal or drop-shaped.

28. The process according to claim 14, wherein the three-dimensional shaped bodies have a dimension along their longest extent of from 0.1 to 20 mm.

29. The process according to claim 14, wherein the binder is a compound selected from the group consisting of polyoxymethylene homopolymers and copolymers, polyalkylene oxides, polyolefins and polymers of acrylic acid and/or acrylic acid esters.
